(19) United States
(12) Patent Application Publication
(10) Pub. No.: US 2026/0360067 A1
(43) Pub. Date: Nov. 12, 2026

(54) TEXT PROCESSING METHOD, ELECTRONIC DEVICE, AND STORAGE MEDIUM

(71) Applicant: Beijing Zitiao Network Technology Co., Ltd., Haidian District (CN)

(72) Inventors: Jing WANG, Beijing (CN); Wang XU, Beijing (CN); Dingding XU, Beijing (CN); Dayu QIU, Beijing (CN); Yubin YU, Beijing (CN); Lushuang CHEN, Beijing (CN)

(21) Appl. No.: 19/666,779

(22) Filed: May 4, 2026

(30) Foreign Application Priority Data
May 7, 2025 (CN) 202510583191.7

(51) Int. Cl. G06T 13/80; G06T 11/60

(52) U.S. Cl. CPC G06T 13/80; G06T 11/60

(57) ABSTRACT

The present disclosure relates to a text processing method and apparatus, an electronic device, and a storage medium. The method includes: segmenting a first text to obtain a plurality of text segments; performing layout on the text segments to obtain laid-out text segments; determining, based on positions of the text segments in the first text, display time periods for the text segments on a timeline and a stacking relationship of the text segments having at least partially overlapping display time periods; and producing a first video based on the display time periods for the text segments on the timeline, the stacking relationship of the text segments having at least partially overlapping display time periods, and the laid-out text segments, where the plurality of text segments gradually appear as time goes by in the first video.

### CROSS-REFERENCE TO RELATED APPLICATIONS

This application claims priority to Chinese Patent Application No. 202510583191.7, entitled “TEXT PROCESSING METHOD AND APPARATUS, ELECTRONIC DEVICE, AND STORAGE MEDIUM”, and filed on May 07, 2025. The entire disclosure of the prior application is hereby incorporated by reference in its entirety.

### TECHNICAL FIELD

The present disclosure relates to the field of information processing technologies, and in particular, to a text processing method, an electronic device, and a storage medium.

### BACKGROUND

In today's era of rapid digital development, text, as the main carrier of information transmission, is becoming increasingly diversified and personalized in its expression. With the popularization of platforms such as social media, instant messaging software, and online forums, people increasingly desire to convey more vivid, interesting, and appealing information through words. To this end, people desire to convert text into video content with a specific layout effect.

### SUMMARY

The present disclosure provides a text processing method, an electronic device, and a storage medium.

In a first aspect, the present disclosure provides a text processing method, including:
segmenting a first text to obtain a plurality of text segments;
performing layout on the text segments to obtain laid-out text segments;
determining, based on positions of the text segments in the first text, display time periods for the text segments on a timeline and a stacking relationship of the text segments having at least partially overlapping display time periods; and
producing a first video based on the display time periods for the text segments on the timeline, the stacking relationship of the text segments having at least partially overlapping display time periods, and the laid-out text segments, where the plurality of text segments gradually appear as time goes by in the first video.

In another aspect, the present disclosure further provides an electronic device, including:
one or more processors;
a storage apparatus, configured to store one or more programs,
where the one or more programs, when executed by the one or more processors, cause the one or more processors to implement the text processing method as described above.

In yet another aspect, the present disclosure further provides a computer-readable storage medium, storing a computer program thereon, where the computer program, when executed by a processor, implements the text processing method as described above.

### BRIEF DESCRIPTION OF THE DRAWINGS

The drawings herein, which are incorporated in and constitute a part of this specification, illustrate embodiments consistent with the present disclosure and, together with the description, serve to explain the principles of the present disclosure.

In order to more clearly explain the technical solutions in embodiments of the present disclosure or in the related art, the drawings required for description of the embodiments or the related art will be briefly introduced below. Obviously, for those of ordinary skill in the art, other drawings can be acquired according to such drawings without paying any creative effort.

FIG. 1 is a flowchart of a text processing method provided by an embodiment of the present disclosure;

FIG. 2 is a schematic diagram of a timeline of a first video provided by an embodiment of the present disclosure;

FIG. 3 is a schematic diagram of a timeline of another first video provided by an embodiment of the present disclosure;

FIG. 4 is a schematic diagram of partial image frames of a first video provided by an embodiment of the present disclosure;

FIG. 5 is a schematic structural diagram of a text processing apparatus provided by an embodiment of the present disclosure; and

FIG. 6 is a schematic structural diagram of an electronic device provided by an embodiment of the present disclosure.

### DETAILED DESCRIPTION OF EMBODIMENTS

In order to understand the above objects, features, and advantages of the present disclosure more clearly, the solutions of the present disclosure will be further described below. It should be noted that, in the absence of a conflict, the embodiments of the present disclosure and the features in the embodiments may be combined with each other.

Many specific details are set forth in the following description to fully understand the present disclosure, but the present disclosure may also be implemented in other ways different from those described herein. Obviously, the described embodiments are part of the embodiments of the present disclosure, but not all of the embodiments.

The traditional text processing method for converting text into video content with a specific layout effect usually requires users to manually produce video image frames frame by frame, which is cumbersome and time-consuming, and cannot achieve the processing purpose of quickly adding visual effects to text.

In order to solve the above technical problems or at least partially solve the above technical problems, the present disclosure provides a text processing method, an electronic device, and a storage medium.

Compared with the related art, the technical solutions provided by embodiments of the present disclosure have the following advantages:
According to the technical solutions provided by embodiments of the present disclosure, a first text is segmented to obtain a plurality of text segments; layout is performed on the text segments to obtain laid-out text segments; display time periods for the text segments on a timeline and a stacking relationship of the text segments having at least partially overlapping display time periods are determined based on positions of the text segments in the first text; and a first video is produced based on the display time periods for the text segments on the timeline, the stacking relationship of the text segments having at least partially overlapping display time periods, and the laid-out text segments, where the plurality of text segments gradually appear as time goes by in the first video. The technical solution is essentially a method that may automatically convert text into video content with a specific layout effect, which may satisfy a requirement of users for quickly adding visual effects to text.

FIG. 1 is a flowchart of a text processing method provided by an embodiment of the present disclosure. The embodiment may be applied to the case of performing text processing in a client. The method may be executed by a text processing apparatus. The apparatus may be implemented by software and/or hardware, and may be configured in an electronic device, such as a terminal, specifically including but not limited to a smart phone, a palmtop computer, a tablet computer, a wearable device with a display screen, a desktop computer, a laptop computer, an all-in-one machine, a smart home device, etc. Alternatively, the embodiment may be applied to the case of performing text processing in a server. The method may be executed by a text processing apparatus. The apparatus may be implemented by software and/or hardware, and may be configured in an electronic device, such as a server.

As shown in FIG. 1, the method may specifically include:
S110, segmenting a first text to obtain a plurality of text segments.

The first text is an object to be processed by the technical solution provided by the present application. By adopting the technical solution provided by the present application, the first text may be converted into video content with a specific layout effect.

The first text, for example, may be information directly input by a user in text form, or information copied from the Internet, or a recognition result obtained by performing text recognition on voice.

Segmenting the first text, for example, may be splitting the first text into a plurality of text segments.

There are various implementation methods for this step, which is not limited in the present application. Exemplarily, the first text may be segmented based on a text feature of the first text and/or a text segmentation constraint condition to obtain the plurality of text segments. The text feature of the first text includes at least one of the following: a part of speech of a phrase in the first text, a dependency between phrases, and a keyword in the first text. The part of speech of the phrase is a grammatical function of the phrase. Exemplarily, the part of speech of the phrase may be a noun, a verb, an adjective, or a preposition, etc. The dependency between the phrases may be, for example, a syntactic collocation relationship between the phrases, which is associated with semantics. The keyword in the first text may be, for example, a phrase that plays a key role in the first text (such as a phrase that reflects a core idea of the first text), or a word with a specific structure (such as a reduplicated word), or a phrase with a special position in the first text, or a phrase with a special pronunciation, or a phrase with a special part of speech, or a phrase that appears repeatedly. The text segmentation constraint condition may be, for example, a condition that limits the number of text segments after segmentation, and/or a condition that limits the maximum number of characters that a single text segment may contain.

Further, there are various methods for determining the keyword in the first text, which is not limited in the present application. Exemplarily, a method for determining the keyword in the first text may include: determining at least two keyword selection rules; determining priorities of the keyword selection rules based on a style feature of the first text; and determining the keyword in the first text based on a keyword selection rule having a priority higher than a set priority level.

The style feature of the first text may be, for example, a language feature presented by the text in terms of language use. The style feature of the first text may be, for example, a feature that reflects a tone, an attitude, an atmosphere created, etc. Exemplarily, the style feature of the first text may be solemn and serious, humorous, easy and casual, kind, sharp, concise and clear, full of mystery and fantasy, etc.

Exemplarily, four keyword selection rules are provided: a phrase that appears in the first text more times than a set number of times threshold; a phrase of which the part of speech is a noun, a verb, or an adverb; a phrase with a pronunciation duration longer than a set duration; and a phrase that is in the first or last position in a sentence. The priority of each keyword selection rule under different style features is set in advance. The style feature of the first text is determined by analyzing the first text, and then the priority of each keyword selection rule under this style feature is specified, and finally the keyword selection rule with the highest priority is determined. It is assumed that the style feature of the first text is sharp. Under this style feature, the keyword selection rule "a phrase with a pronunciation duration longer than a set duration" has the highest priority. The keyword is determined in the first text based on this keyword selection rule.

S120, performing layout on the text segments to obtain laid-out text segments.

Performing layout on the text segments is essentially setting display styles of the text segments in a first video. The first video is a video that may be obtained by adopting the technical solution provided by the present application. The laid-out text segments carry attribute values related to their display styles in the first video.

Exemplarily, an implementation method of this step may include: performing layout on the text segments by using a preset text segment layout rule to obtain the laid-out text segments. The content specifically included in the text segment layout rule is not limited in the present application. Exemplarily, the text segment layout rule includes a limitation on at least one of the following contents: 1. text style: font, font size, line spacing, character spacing, color, glowing effect, and alignment; 2. animation attribute: list of animation effects (entrance/loop/exit) that may be added to the text segments, animation frequency, and animation proportion; 3. position setting: position of the text segments in a picture, such as set to a random position, or displayed in a specified position in the picture, or dynamically determined based on the text segments that have been displayed on a page, or a fixed position in the picture may also be specified for the text segments; 4. display duration: display duration of the text segments; 5. dynamic characteristic: moving characteristic, size changing characteristic, and color changing characteristic of the text segments in the picture during the display of the text segments; 6. character display: character display mode of the text segments, for example, character by character, or all at once.

S130, determining, based on positions of the text segments in the first text, display time periods for the text segments on a timeline and a stacking relationship of the text segments having at least partially overlapping display time periods.

The display time periods for the text segments on the timeline refer to the specific positions of the text segments on the timeline of the first video, such as the time at which the text segments start to be displayed and the time at which the text segments stop being displayed on the timeline. The first video is a video obtained by adopting the technical solution provided by the present application, and is a video with a specific layout effect obtained by processing the first text.

The stacking relationship refers to an overlapping relationship between the text segments during display. In some scenes, the text segment in an upper layer may cover the text segment in a lower layer.

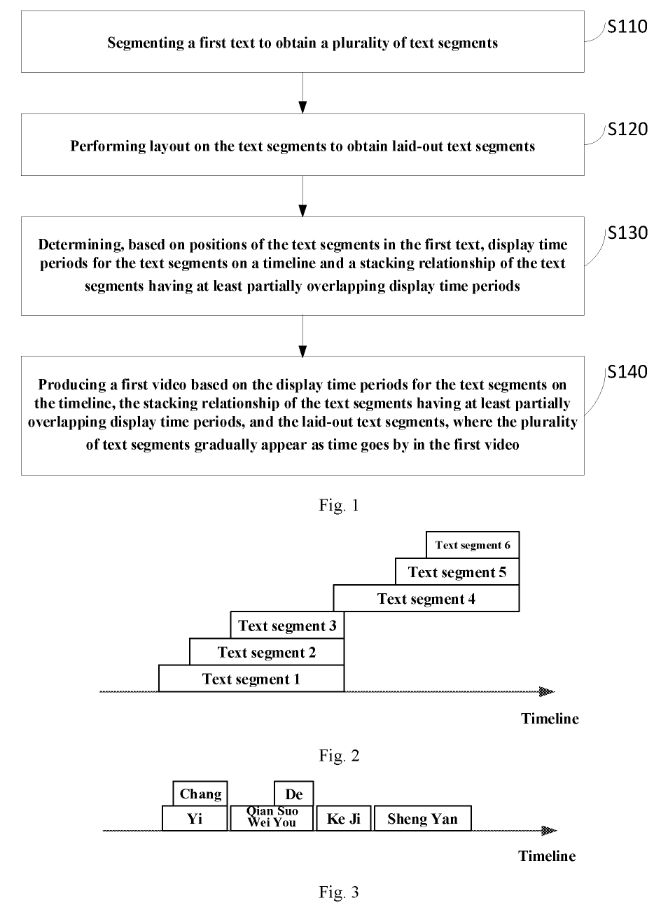

Exemplarily, FIG. 2 is a schematic diagram of a timeline provided by the present application. The timeline is a timeline of a first video. It is assumed that 6 text segments are obtained by segmenting a first text. The purpose of this step is to determine the specific positions of the 6 text segments on the timeline.

In practice, the display time periods for different text segments on the timeline may not overlap with each other, or may at least partially overlap. Exemplarily, in FIG. 2, the display time periods for text segment 1 and text segment 6 on the timeline do not overlap with each other. The display time periods for text segment 1 and text segment 2 on the timeline partially overlap. Specifically, the display time period for text segment 1 on the timeline includes the display time period for text segment 2 on the timeline. In this case, the stacking relationship of the two text segments needs to be considered. In FIG. 2, in the direction perpendicular to the timeline, the closer a text segment is to the timeline, the lower its stacking position, and the farther a text segment is from the timeline, the higher its stacking position. For example, text segment 2 is above text segment 1. If text segment 2 is set to be non-transparent, text segment 2 will cover text segment 1.

In practice, optionally, a time period planning constraint condition may be set in advance. When this step is executed, optionally, the display time periods for the text segments on the timeline and the stacking relationship of the text segments having at least partially overlapping display time periods are determined based on the positions of the text segments in the first text and the time period planning constraint condition. The purpose of setting the time period planning constraint condition here is to ensure that the generated first video may present text information coherently and dynamically within a reasonable duration range, and avoid an excessively long duration of the first video. The content specifically included in the time period planning constraint condition is not limited in the present application. In practice, optionally, the time period planning constraint condition includes at least one of the following: the number of tracks included in the first video is less than a set number of tracks threshold, the display sequence of different text segments is consistent with their positions in the first text, the display time periods for text segments in a same track on the timeline do not overlap, and the display sequence is correct; the minimum time interval between adjacent text segments in the same track is less than a preset first duration threshold; and the duration of the display time period for any text segment is greater than a preset second duration threshold.

Since there is a case that text segments having at least partially overlapping display time periods are stacked and displayed, it means that the text segments will be displayed in different layers. The tracks are used to organize and manage the display time periods for the text segments displayed in the same layer, so that the text segments may be presented at the correct time points and in the correct order. Exemplarily, FIG. 2 includes 6 layers in total in the direction perpendicular to the timeline, which means that in this example, 6 tracks are used in total to manage the display time periods for the text segments. The number of tracks threshold may be, for example, a pre-specified number. If the number of tracks included in the first video is less than the set number of tracks threshold, it means that the fewer the number of layers used for displaying the text segments in the first video, the lower the complexity of the first video, and the more conducive it is to the subsequent rapid production of the first video.

In some scenes, when performing layout on the text segments, display duration may be configured for the text segments, which may cause the layout information of the laid-out text segments to possibly carry information that reflects the display duration of the text segments. In view of this, it may be provided that when this step is executed, the display time periods for the text segments on the timeline and the stacking relationship of the text segments having at least partially overlapping display time periods are determined according to the positions of the text segments in the first text and the layout information of the text segments.

S140, producing a first video based on the display time periods for the text segments on the timeline, the stacking relationship of the text segments having at least partially overlapping display time periods, and the laid-out text segments, where the plurality of text segments gradually appear as time goes by in the first video.

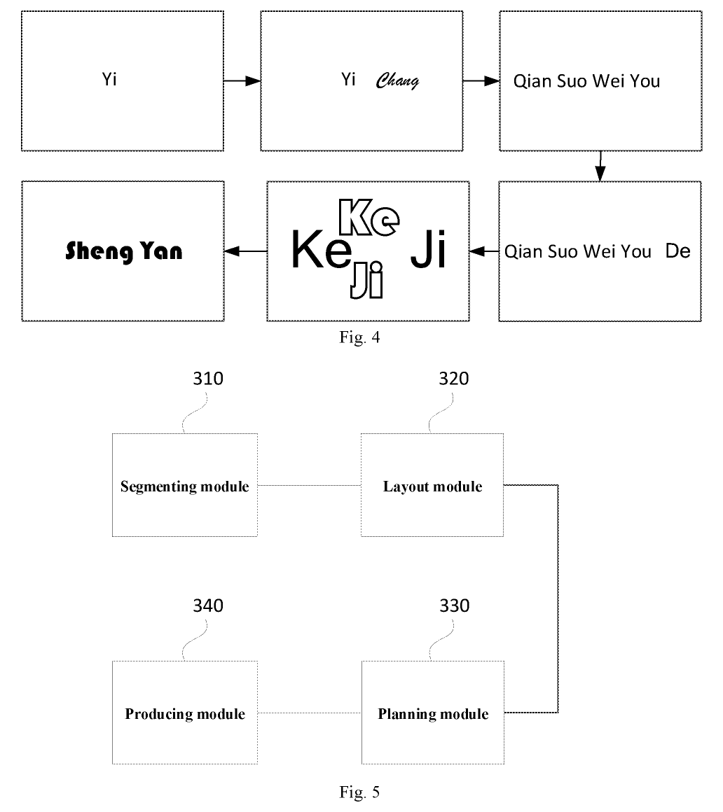

Exemplarily, if the first text is "Yi Chang Qian Suo Wei You De Ke Ji Sheng Yan" (which means “An unprecedented technological feast”), the text segments obtained by segmenting it are " Yi ", "Chang", "Qian Suo Wei You", "De", "Ke Ji", and "Sheng Yan", respectively. Each of the text segments is adjusted, such as by setting the font, color, size, entrance animation, etc., of the text segment. Then the display time periods for the text segments on the timeline and the stacking relationship of the text segments having at least partially overlapping display time periods are determined according to the positions of the text segments in the first text. The determined result (the display time periods for the text segments on the timeline and the stacking relationship of the text segments having at least partially overlapping display time periods) is shown in FIG. 3. The first video is obtained based on the display time periods for the text segments on the timeline, the stacking relationship of the text segments having at least partially overlapping display time periods, and the laid-out text segments. In FIG. 4, a schematic diagram of several image frames is exemplarily shown. It may be seen from FIG. 4 that as time goes by, the text segments gradually appear in the order of the text segments in the first text.

According to the above technical solution, a first text is segmented to obtain a plurality of text segments; layout is performed on the text segments to obtain laid-out text segments; display time periods for the text segments on a timeline and a stacking relationship of the text segments having at least partially overlapping display time periods are determined according to positions of the text segments in the first text; and a first video is produced based on the display time periods for the text segments on the timeline, the stacking relationship of the text segments having at least partially overlapping display time periods, and the laid-out text segments, where the plurality of text segments gradually appear as time goes by in the first video. The technical solution is essentially a method that may automatically convert text into video content with a specific layout effect, which may satisfy a requirement of users for quickly adding visual effects to text.

Based on the preceding technical solution, optionally, the method may further include: determining a first text processing rule, where the first text processing rule includes a text segmentation constraint condition and a text segment layout rule; S110 may include: segmenting the first text based on the text segmentation constraint condition to obtain the plurality of text segments; and S120 may include: performing layout on the text segments by using the text segment layout rule to obtain the laid-out text segments. The essence of such setting is to bind the text segmentation constraint condition and the text segment layout rule together as a text processing rule. In this manner, when it is determined to use a certain text processing rule for the first text, the text segmentation constraint condition included in the text processing rule may be automatically invoked to segment the first text, and the text segment layout rule may be invoked to perform layout on the text segments. In practice, the text segmentation constraint condition and the text segment layout rule that have a better matching effect may be bound to improve the display effect of the first video.

There are various specific implementation methods for determining the first text processing rule, which is not limited in the present application. In some scenes, identifications of different text processing rules may be displayed for the user to select. In response to the user’s selection operation (such as a click operation, a slide operation, or a drag-and-drop operation, etc.) on the identification of a certain text processing rule, the text processing rule referred to by the identification of the text processing rule selected by the user is used as the first text processing rule. The identification of the text processing rule may be, for example, information used to distinguish different text processing rules. The identification of the text processing rule may include one or more of the name of the text processing rule, a brief introduction of the text processing rule, an applicable scene of the text processing rule, and a category of the text applicable for processing by the text processing rule.

In some other scenes, optionally, determining the first text processing rule may include: obtaining a text processing rule set, where the text processing rule set includes a plurality of text processing rules, and the text processing rules have corresponding labels; and determining the first text processing rule in the text processing rule set based on a relevance between a category feature of the first text and the labels of the text processing rules.

The label of the text processing rule may be, for example, description information that describes the category of the text to which the text processing rule is applicable for processing. The category feature of the first text may reflect, for example, the information about which category the first text belongs to.

In practice, a classification standard for the text category may be set in advance, and corresponding text processing rules may be set for different text categories. The label of the text processing rule describes the category of the text to which the text processing rule is applicable for processing. The category feature of the first text may be obtained by performing semantic understanding on the first text. The relevance between the category feature of the first text and the label of the text processing rule is calculated, and the text processing rule with the highest relevance with the category feature of the first text is used as the first text processing rule.

By setting to determine the first text processing rule in the text processing rule set based on the relevance between the category feature of the first text and the labels of the text processing rules, the first text processing rule may be adapted to the first text, so that the finally obtained first video has a better visual effect.

Further, if the text segment layout rule includes a first rule and a second rule, performing layout on the text segments based on the text segment layout rule to obtain the laid-out text segments may include: determining a first text segment and a second text segment in the text segments; performing layout on the first text segment based on the first rule to obtain a laid-out first text segment; and performing layout on the second text segment based on the first rule and the second rule to obtain a laid-out second text segment.

In practice, all the text segments segmented from the first text may be used as the first text segment, and the second text segment is a subset of the text segments selected from all the text segments segmented from the first text. The selection standard for the second text segment is not limited in the present application. In practice, the second text segment may or may not include the keyword of the first text as mentioned above. The first rule may be understood as a general layout rule for performing layout on all the text segments. The second rule may be, for example, a special layout rule only for performing layout on the second text segment. The specific rules of the first rule and the second rule are not limited in the present application. Exemplarily, the first rule includes a rule on a text style and/or an animation attribute. The second rule includes a rule on a dynamic characteristic and/or character display.

The first text segment and the second text segment are determined in the text segments; layout is performed on the first text segment based on the first rule to obtain the laid-out first text segment; and layout is performed on the second text segment based on the first rule and the second rule to obtain the laid-out second text segment. The purpose is to enable the second text segment to have a more prominent visual effect than the first text segment.

Based on the preceding technical solution, optionally, S140 may further include: configuring motion attributes of the text segments; and producing the first video based on the motion attributes of the text segments, the display time periods for the text segments on the timeline, the stacking relationship of the text segments having at least partially overlapping display time periods, and the laid-out text segments. Herein, configuring the motion attributes of the text segments may be a global configuration, that is, the motion attributes of all the text segments are configured in a unified manner. In other words, configuring the motion attributes of the text segments may affect each of the text segments. Configuring the motion attributes of the text segments may include: setting the text segments to move along a preset trajectory, swing in a specific direction by a preset amplitude, perform a rotation action, scale, etc., during their display.

The motion attributes of the text segments are configured, and the first video is produced based on the motion attributes of the text segments, the display time periods for the text segments on the timeline, the stacking relationship of the text segments having at least partially overlapping display time periods, and the laid-out text segments, so that the first video may have a better visual effect.

It may be understood that before the technical solutions disclosed in the embodiments of the present disclosure are used, the user shall be informed of the type, range of use, use scenarios, etc., of personal information involved in the present disclosure in an appropriate manner in accordance with relevant laws and regulations and the authorization of the user shall be obtained.

For example, in response to receiving an active request from a user, prompt information is sent to the user to clearly prompt the user that the requested operation will require access to and use of the user’s personal information. In this manner, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also carry a selection control for the user to choose whether to "agree" or "disagree" to provide the personal information to the electronic device.

It may be understood that the preceding process of notifying and obtaining user authorization is only illustrative and does not limit the implementations of the present disclosure. Other manners that satisfy the relevant laws and regulations may also be applied to the implementations of the present disclosure.

It should be noted that for the sake of simple description, the preceding method embodiments are all expressed as a series of action combinations, but those skilled in the art should know that the present disclosure is not limited by the described order of actions, because according to the present disclosure, certain steps may be performed in other orders or simultaneously. Secondly, those skilled in the art should also know that the embodiments described in the specification all belong to preferred embodiments, and the involved actions and modules are not necessarily required by the present disclosure.

FIG. 5 is a schematic structural diagram of a text processing apparatus according to an embodiment of the present disclosure. The text processing apparatus provided by the embodiment of the present disclosure may be configured in a client or a server. Referring to FIG. 5, the text processing apparatus specifically includes:
a segmenting module 310, configured to segment a first text to obtain a plurality of text segments;
a layout module 320, configured to perform layout on the text segments to obtain laid-out text segments;
a planning module 330, configured to determine, based on positions of the text segments in the first text, display time periods for the text segments on a timeline and a stacking relationship of the text segments having at least partially overlapping display time periods; and
a producing module 340, configured to produce a first video based on the display time periods for the text segments on the timeline, the stacking relationship of the text segments having at least partially overlapping display time periods, and the laid-out text segments, where the plurality of text segments gradually appear as time goes by in the first video.

Further, the apparatus further includes a rule determination module, configured to determine a first text processing rule, where the first text processing rule includes a text segmentation constraint condition and a text segment layout rule;
the segmenting module 310 is configured to segment the first text based on the text segmentation constraint condition to obtain the plurality of text segments; and
the layout module 320 is configured to perform layout on the text segments by using the text segment layout rule to obtain the laid-out text segments.

Further, the rule determination module is configured to:
obtain a text processing rule set, where the text processing rule set includes a plurality of text processing rules, and the text processing rules have corresponding labels; and
determine the first text processing rule in the text processing rule set based on a relevance between a category feature of the first text and the labels of the text processing rules.

Further, the segmenting module 310 is configured to:
segment the first text based on the text segmentation constraint condition and a text feature of the first text to obtain the plurality of text segments, where the text feature of the first text includes at least one of the following: a part of speech of a phrase in the first text, a dependency between phrases, and a keyword in the first text.

Further, the apparatus further includes a keyword determination module, configured to:
determine at least two keyword selection rules;
determine priorities of the keyword selection rules based on a style feature of the first text; and
determine the keyword in the first text based on a keyword selection rule having a priority higher than a set priority level.

Further, the text segment layout rule includes a first rule and a second rule, and the layout module 320 is configured to:
determine a first text segment and a second text segment in the text segments;
perform layout on the first text segment based on the first rule to obtain a laid-out first text segment; and
perform layout on the second text segment based on the first rule and the second rule to obtain a laid-out second text segment.

Further, the producing module 340 is configured to:
configure motion attributes of the text segments; and
produce the first video based on the motion attributes of the text segments, the display time periods for the text segments on the timeline, the stacking relationship of the text segments having at least partially overlapping display time periods, and the laid-out text segments.

The text processing apparatus provided by the embodiment of the present disclosure may execute the steps performed by the client or the server in the text processing method provided by the method embodiment of the present disclosure, and has the corresponding beneficial effects, which will not be repeated herein.

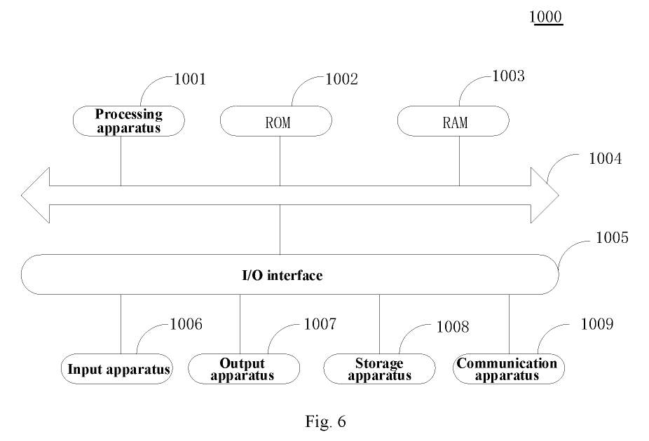

FIG. 6 is a schematic structural diagram of an electronic device according to an embodiment of the present disclosure. The following specifically shows, with reference to FIG. 6, a schematic structural diagram of an electronic device 1000 suitable for implementing an embodiment of the present disclosure. The electronic device 1000 in the embodiment of the present disclosure may include, but is not limited to, mobile terminals such as a mobile phone, a laptop computer, a digital broadcast receiver, a personal digital assistant (PDA), a tablet computer, a portable media player (PMP), an in-vehicle terminal (such as an in-vehicle navigation terminal), and a wearable electronic device, and fixed terminals such as a digital TV, a desktop computer, and a smart home device. The electronic device shown in FIG. 6 is only an example, and should not impose any limitation on the function and scope of use of the embodiments of the present disclosure.

As shown in FIG. 6, the electronic device 1000 may include a processing apparatus 1001 (such as a central processing unit, a graphics processing unit, etc.), which may perform various appropriate actions and processing based on a program stored in a read-only memory (ROM) 1002 or a program loaded from a storage apparatus 1008 into a random access memory (RAM) 1003 to implement the text processing method of the embodiment as described in the present disclosure. The RAM 1003 further stores various programs and information required for the operation of the electronic device 1000. The processing apparatus 1001, the ROM 1002, and the RAM 1003 are connected to each other through a bus 1004. An input/output (I/O) interface 1005 is also connected to the bus 1004.

Usually, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a speaker, and a vibrator; a storage apparatus 1008 including, for example, a magnetic tape and a hard disk; and a communication apparatus 1009. The communication apparatus 1009 may allow the electronic device 1000 to perform wireless or wired communication with other devices to exchange information. Although FIG. 6 shows the electronic device 1000 with various apparatuses, it should be understood that it is not required to implement or provide all the apparatuses shown. Alternatively, more or fewer apparatuses may be implemented or provided.

In particular, according to the embodiment of the present disclosure, the process described above with reference to the flowchart may be implemented as a computer software program. For example, the embodiment of the present disclosure includes a computer program product, which includes a computer program carried on a non-transitory computer-readable medium, where the computer program contains program code for performing the method shown in the flowchart, to implement the text processing method as described above. In such an embodiment, the computer program may be downloaded and installed from a network through the communication apparatus 1009, or installed from the storage apparatus 1008, or installed from the ROM 1002. When the computer program is executed by the processing apparatus 1001, the preceding functions defined in the method of the embodiment of the present disclosure are executed.

It should be noted that the preceding computer-readable medium in the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, the computer-readable signal medium may include an information signal propagated on a baseband or as a part of a carrier, and computer-readable program code is carried therein. The information signal propagated in this manner may be in various forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to a wire, an optical cable, a radio frequency (RF), or any suitable combination thereof.

In some implementations, the client and the server may communicate using any network protocol known or to be developed in the future, such as the hypertext transfer protocol (HTTP), and may be interconnected with any form or medium of digital information communication (for example, a communication network). Examples of the communication network include a local area network ("LAN"), a wide area network ("WAN"), an internet (for example, the Internet), a peer-to-peer network (for example, an ad hoc network), and any network known or to be developed in the future.

The computer-readable medium may be included in the electronic device or may exist alone without being assembled into the electronic device.

The computer-readable medium carries one or more programs, which, when executed by the electronic device, cause the electronic device to:
segment a first text to obtain a plurality of text segments;
perform layout on the text segments to obtain laid-out text segments;
determine, based on positions of the text segments in the first text, display time periods for the text segments on a timeline and a stacking relationship of the text segments having at least partially overlapping display time periods; and
produce a first video based on the display time periods for the text segments on the timeline, the stacking relationship of the text segments having at least partially overlapping display time periods, and the laid-out text segments, where the plurality of text segments gradually appear as time goes by in the first video.

Optionally, when the one or more programs are executed by the electronic device, the electronic device may further perform the other steps described in the preceding embodiments.

The computer program code for performing the operations of the present disclosure may be written in one or more programming languages or a combination thereof, where the programming languages include but are not limited to object-oriented programming languages such as Java, Smalltalk, and C++, and also include conventional procedural programming languages such as "C" language or similar programming languages. The program code may be executed entirely on a user computer, partly on the user computer, as a stand-alone software package, partly on the user computer and partly on a remote computer, or entirely on the remote computer or a server. In the case of the remote computer, the remote computer may be connected to the user computer through any kind of network, including a local area network (LAN) or a wide area network (WAN), or may be connected to an external computer (for example, connected through the Internet using an Internet service provider).

The flowchart and block diagrams in the drawings illustrate the architecture, functionality, and operation of possible implementations of the systems, methods and computer program products according to various embodiments of the present disclosure. In this regard, each block in the flowchart or block diagrams may represent a module, program segment, or portion of code, which includes one or more executable instructions for implementing the specified logical function(s). It should also be noted that, in some alternative implementations, the functions noted in the block may occur in an order different from that noted in the drawings. For example, two blocks shown in succession may, in fact, be executed substantially concurrently, or the blocks may sometimes be executed in a reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

The units involved in the embodiments described in the present disclosure may be implemented by software or hardware. The name of a unit does not constitute a limitation on the unit itself under certain circumstances.

The functions described above may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the preceding. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the preceding.

According to one or more embodiments of the present disclosure, the present disclosure provides an electronic device, including:
one or more processors;
a memory, configured to store one or more programs,
where the one or more programs, when executed by the one or more processors, cause the one or more processors to implement any of the text processing method provided in the present disclosure.

According to one or more embodiments of the present disclosure, the present disclosure provides a computer-readable storage medium, storing a computer program thereon, where the computer program, when executed by a processor, implements any of the text processing method provided in the present disclosure.

An embodiment of the present disclosure further provides a computer program product, which includes a computer program or instructions, where the computer program or instructions, when executed by a processor, implement the text processing method as described above.

It should be noted that in this paper, relational terms such as "first" and "second" are only used to distinguish one entity or operation from another entity or operation, and do not necessarily require or imply any such actual relationship or order between these entities or operations. Moreover, the terms "include", "comprise" or any other variation thereof are intended to cover non-exclusive inclusion, so that a process, method, object or device including a series of elements includes not only those elements, but also other elements not explicitly listed or elements inherent to such process, method, object or device. Without further restrictions, an element defined by the phrase "includes a..." does not exclude the existence of other identical elements in the process, method, object or device including the element.

The preceding descriptions are only specific implementations of the present disclosure, so that those skilled in the art may understand or implement the present disclosure. Various modifications to these embodiments will be apparent to those skilled in the art, and the generic principles defined herein may be implemented in other embodiments without departing from the spirit or scope of the present disclosure. Therefore, the present disclosure will not be limited to the embodiments described herein, but rather to the widest scope consistent with the principles and novel features disclosed herein.

1. A text processing method, comprising:
segmenting a first text to obtain a plurality of text segments;
performing layout on the text segments to obtain laid-out text segments;
determining, based on positions of the text segments in the first text, display time periods for the text segments on a timeline and a stacking relationship of the text segments having at least partially overlapping display time periods; and
producing a first video based on the display time periods for the text segments on the timeline, the stacking relationship of the text segments having at least partially overlapping display time periods, and the laid-out text segments, wherein the plurality of text segments gradually appear as time goes by in the first video.

2. The method of claim 1, further comprising:
determining a first text processing rule, wherein the first text processing rule comprises a text segmentation constraint condition and a text segment layout rule;
wherein the segmenting the first text to obtain the plurality of text segments comprises: segmenting the first text based on the text segmentation constraint condition to obtain the plurality of text segments; and
the performing layout on the text segments to obtain the laid-out text segments comprises: performing layout on the text segments by using the text segment layout rule to obtain the laid-out text segments.

3. The method of claim 2, wherein the determining the first text processing rule comprises:
obtaining a text processing rule set, wherein the text processing rule set comprises a plurality of text processing rules, and the text processing rules have corresponding labels; and
determining the first text processing rule in the text processing rule set based on a relevance between a category feature of the first text and the labels of the text processing rules.

4. The method of claim 2, wherein the segmenting the first text based on the text segmentation constraint condition to obtain the plurality of text segments comprises:
segmenting the first text based on the text segmentation constraint condition and a text feature of the first text to obtain the plurality of text segments, wherein the text feature of the first text comprises at least one of the following: a part of speech of a phrase in the first text, a dependency between phrases, and a keyword in the first text.

5. The method of claim 4, wherein determining the keyword in the first text comprises:
determining at least two keyword selection rules;
determining priorities of the keyword selection rules based on a style feature of the first text; and
determining the keyword in the first text based on a keyword selection rule having a priority higher than a set priority level.

6. The method of claim 2, wherein the text segment layout rule comprises a first rule and a second rule, and the performing layout on the text segments by using the text segment layout rule to obtain the laid-out text segments comprises:
determining a first text segment and a second text segment in the text segments;
performing layout on the first text segment based on the first rule to obtain a laid-out first text segment; and
performing layout on the second text segment based on the first rule and the second rule to obtain a laid-out second text segment.

7. The method of claim 1, wherein the producing the first video based on the display time periods for the text segments on the timeline, the stacking relationship of the text segments having at least partially overlapping display time periods, and the laid-out text segments comprises:
configuring motion attributes of the text segments; and
producing the first video based on the motion attributes of the text segments, the display time periods for the text segments on the timeline, the stacking relationship of the text segments having at least partially overlapping display time periods, and the laid-out text segments.

8. An electronic device, comprising:
one or more processors;
a storage apparatus, configured to store one or more programs,
wherein the one or more programs, when executed by the one or more processors, cause the one or more processors to implement a text processing method, comprising:
segmenting a first text to obtain a plurality of text segments;
performing layout on the text segments to obtain laid-out text segments;
determining, based on positions of the text segments in the first text, display time periods for the text segments on a timeline and a stacking relationship of the text segments having at least partially overlapping display time periods; and
producing a first video based on the display time periods for the text segments on the timeline, the stacking relationship of the text segments having at least partially overlapping display time periods, and the laid-out text segments, wherein the plurality of text segments gradually appear as time goes by in the first video.

9. The electronic device of claim 8, wherein the text processing method further comprises:
determining a first text processing rule, wherein the first text processing rule comprises a text segmentation constraint condition and a text segment layout rule;
wherein the segmenting the first text to obtain the plurality of text segments comprises: segmenting the first text based on the text segmentation constraint condition to obtain the plurality of text segments; and
the performing layout on the text segments to obtain the laid-out text segments comprises: performing layout on the text segments by using the text segment layout rule to obtain the laid-out text segments.

10. The electronic device of claim 9, wherein the determining the first text processing rule comprises:
obtaining a text processing rule set, wherein the text processing rule set comprises a plurality of text processing rules, and the text processing rules have corresponding labels; and
determining the first text processing rule in the text processing rule set based on a relevance between a category feature of the first text and the labels of the text processing rules.

11. The electronic device of claim 9, wherein the segmenting the first text based on the text segmentation constraint condition to obtain the plurality of text segments comprises:
segmenting the first text based on the text segmentation constraint condition and a text feature of the first text to obtain the plurality of text segments, wherein the text feature of the first text comprises at least one of the following: a part of speech of a phrase in the first text, a dependency between phrases, and a keyword in the first text.

12. The electronic device of claim 11, wherein determining the keyword in the first text comprises:
determining at least two keyword selection rules;
determining priorities of the keyword selection rules based on a style feature of the first text; and
determining the keyword in the first text based on a keyword selection rule having a priority higher than a set priority level.

13. The electronic device of claim 9, wherein the text segment layout rule comprises a first rule and a second rule, and the performing layout on the text segments by using the text segment layout rule to obtain the laid-out text segments comprises:
determining a first text segment and a second text segment in the text segments;
performing layout on the first text segment based on the first rule to obtain a laid-out first text segment; and
performing layout on the second text segment based on the first rule and the second rule to obtain a laid-out second text segment.

14. The electronic device of claim 8, wherein the producing the first video based on the display time periods for the text segments on the timeline, the stacking relationship of the text segments having at least partially overlapping display time periods, and the laid-out text segments comprises:
configuring motion attributes of the text segments; and
producing the first video based on the motion attributes of the text segments, the display time periods for the text segments on the timeline, the stacking relationship of the text segments having at least partially overlapping display time periods, and the laid-out text segments.

15. A non-transitory computer-readable storage medium, storing a computer program thereon, wherein the computer program, when executed by a processor, implements a text processing method, comprising:
segmenting a first text to obtain a plurality of text segments;
performing layout on the text segments to obtain laid-out text segments;
determining, based on positions of the text segments in the first text, display time periods for the text segments on a timeline and a stacking relationship of the text segments having at least partially overlapping display time periods; and
producing a first video based on the display time periods for the text segments on the timeline, the stacking relationship of the text segments having at least partially overlapping display time periods, and the laid-out text segments, wherein the plurality of text segments gradually appear as time goes by in the first video.

16. The non-transitory computer-readable storage medium of claim 15, wherein the text processing method further comprises:
determining a first text processing rule, wherein the first text processing rule comprises a text segmentation constraint condition and a text segment layout rule;
wherein the segmenting the first text to obtain the plurality of text segments comprises: segmenting the first text based on the text segmentation constraint condition to obtain the plurality of text segments; and
the performing layout on the text segments to obtain the laid-out text segments comprises: performing layout on the text segments by using the text segment layout rule to obtain the laid-out text segments.

17. The non-transitory computer-readable storage medium of claim 16, wherein the determining the first text processing rule comprises:
obtaining a text processing rule set, wherein the text processing rule set comprises a plurality of text processing rules, and the text processing rules have corresponding labels; and
determining the first text processing rule in the text processing rule set based on a relevance between a category feature of the first text and the labels of the text processing rules.

18. The non-transitory computer-readable storage medium of claim 16, wherein the segmenting the first text based on the text segmentation constraint condition to obtain the plurality of text segments comprises:
segmenting the first text based on the text segmentation constraint condition and a text feature of the first text to obtain the plurality of text segments, wherein the text feature of the first text comprises at least one of the following: a part of speech of a phrase in the first text, a dependency between phrases, and a keyword in the first text.

19. The non-transitory computer-readable storage medium of claim 18, wherein determining the keyword in the first text comprises:
determining at least two keyword selection rules;
determining priorities of the keyword selection rules based on a style feature of the first text; and
determining the keyword in the first text based on a keyword selection rule having a priority higher than a set priority level.

20. The non-transitory computer-readable storage medium of claim 16, wherein the text segment layout rule comprises a first rule and a second rule, and the performing layout on the text segments by using the text segment layout rule to obtain the laid-out text segments comprises:
determining a first text segment and a second text segment in the text segments;
performing layout on the first text segment based on the first rule to obtain a laid-out first text segment; and
performing layout on the second text segment based on the first rule and the second rule to obtain a laid-out second text segment.
